(19) United States
(12) Patent Application Publication
(10) Pub. No.: US 2003/0143947 A1
(43) Pub. Date: Jul. 31, 2003

(54) System and method for daisy-chained optical repeaters

(75) Inventor: Jae Woo Lyu, Daebang-Dong (KR)

Correspondence Address: FLESHNER & KIM, LLP, P.O. Box 221200, Chantilly, VA, 20153-1200, US

(73) Assignee: LG Electronics Inc.

(21) Appl. No.: 10/029,261

(22) Filed: Dec. 28, 2001

(30) Foreign Application Priority Data
Dec. 28, 2000 (KR) 83736/2000

(51) Int. Cl. H04B 7/14

(52) U.S. Cl. 455/7; 455/561

(57) ABSTRACT

The system and method for daisy-chained optical repeaters includes multiple optical repeaters connected in series by optical cables. The final optical repeater is connected to a base station by an optical cable. Each optical repeater includes a digital summer. In operation, each optical repeater sums a converted baseband digital signal with a baseband digital signal from a prior stage. The final stage transmits the summed baseband digital signal to the base station. The system and method advantageously reduces system cost and further reduces the level of noise in a signal received by the base station.

### BACKGROUND OF THE INVENTION

1. Field of the Invention

The present invention relates to an optical communication system, more and particularly to an apparatus and method for transmitting baseband digital signals of a plurality of optical repeaters.

2. Background of the Related Art

In the past, Digital Cellular and Personal Communication Service mobile communication entrepreneurs had to add base stations to extend service areas and increase the reach of a wireless communication network. However, base stations are added at considerable cost and delay. Recently, mobile communication entrepreneurs are adding optical repeaters rather than additional base stations to extend service areas and improve the quality of service in a more cost-effective manner. A repeater system amplifies and retransmits signals in regions where reception by a terminal is otherwise impossible due to weak signal strength. For example, signal strength may be weak in an underground space, an underground shopping district, a tunnel, an underground of a building, and inside buildings. Repeaters can allow a user to receive service in all such areas.

To utilize repeaters, a radio frequency (RF) signal of a base station is reproduced by transmitting the signal to a preferable remote position through a third transmitting medium. The RF signal is a general broadband signal including frequencies from 10 KHz to 100 KHz. Such frequencies are typical in electromagnetic wave communications.

Repeater types include an optical repeater, a frequency converting repeater, a microwave (M/W) repeater, and a laser repeater. Such repeaters typically include an interference canceller to prevent an oscillation or an electric vibration generated by a phase control circuit inside the repeater.

An optical repeater is an apparatus with a remote antenna configured to function as an antenna attached to a base station. The remote antenna of the optical repeater is typically a diversity antenna for extending the service area and canceling a shadow area by transmitting a signal between a base station and a moving station in a wireless communication service region using the Code Division Multiple Access (CDMA) method. A inputted RF electronic signal is converted to an RF optical signal and transmitted through an optical cable to a shadow area for transmission. Thus a shadow area is eliminated, and the service area is extended.

Such optical repeater includes a donor portion to process a baseband signal of a base station and to generate the RF optical signal, and a remote portion that interfaces to the optical cable and outputs a wireless RF signal.

In the optical repeater, the process of receiving an analog signal generated in the base station, digitalizing the signal in the donor portion, calculating, processing, and transmitting the result to the remote portion is very important for overcoming attenuation in transmitting an optical signal. Where the signal modulated to the RF optical signal is a digital signal, undesirable effects such as attenuation, noise, and InterModulation Distortion (IMD) are substantially avoided.

FIG. 1 is a block diagram showing a related art optical communication system including an analog optical repeater. As shown therein, the optical communication system includes a plurality (1-N) of analog optical repeaters 200 and a CDMA master base station 300 connected to the optical repeaters 200 by optical cables (1-N), respectively. The optical repeaters 200 each include an antenna 210 to receive a RF analog signal, a low noise tuning amplifier 220 to reduce internal noise, control the amplifying gain and amplify the RF analog signal. Each of the optical repeaters 200 further include an Electrical signal to Optical signal (E/O) converter 230 to convert the RF electric analog signal to the RF optical signal.

The CDMA master base station 300 includes an optical combiner 310 to sum the RF optical signals transmitted from optical repeaters 200 and an Optical signal to Electrical signal (O/E) converter 320 to convert the RF analog optical signal to a RF analog electrical signal. The base station 300 also includes a band-pass filter (BPF) 330 to filter the RF analog signal to a RF band determined in the optical repeater 200, and an amplifier 340 to amplify the RF signal received from the BPF 330. The base station 300 further includes a Frequency converter 350 to convert the RF analog signal received from the amplifier 340 to a baseband digital signal, a CDMA modem 370 to demodulate the digital signal outputted from the Frequency converter 350 and an automatic gain control (AGC) circuit 360 to control a gain of the amplifier 340.

The Frequency converter 350 includes a mixer (not shown) to convert the RF analog signal into a baseband analog signal, and an analog to digital converter (ADC) (also not shown) to convert the baseband analog signal received from the mixer to a baseband digital signal.

The process for signal processing in an optical communication system including a related art analog optical repeater will be described with reference to FIG. 1. The antenna 210 of the optical repeater 200 receives and transmits the RF analog electrical signal Arf_{—}1(t) to the low noise tuning amplifier 220. The low noise tuning amplifier 220 outputs the RF analog electrical signal having lower noise level to the E/O converter 230. The E/O converter 230 transmits the converted RF analog optical signal to the optical combiner 310 of the CDMA master base station 300 through an optical cable after converting the received RF analog electrical signal to a RF analog optical signal.

The Optical combiner 310 outputs summed RF analog optical signals from a plurality of repeaters 200 to the O/E converter 320. The O/E converter outputs converted RF analog electrical signals Arf_m(t) to the BPF 330 after converting the received RF analog optical signal to a RF analog electrical signal. The BPF 330 filters the size of the received RF analog electrical signal Arf_m(t) and then outputs the filtered RF signal to the amplifier 340. The amplifier 340 amplifies the received RF analog electrical signal with a prescribed gain and outputs the amplified RF analog electrical signal to the mixer of the Frequency converter 350. The mixer converts the RF analog signal into a baseband analog signal and outputs the baseband analog signal to the ADC of the frequency converter 350. The ADC converts the baseband analog signal received from the mixer into a baseband digital analog signal and outputs it to the CDMA modem 370.

The CDMA modem 370 demodulates the received baseband digital signal. The AGC circuit 360 controls the amplifier 340 to output the prescribed gain. The AGC 360 maintains the amplitude of the baseband analog signal inputted to the ADC of the Frequency converter 350.

There are various problems in using the optical repeaters of the related art to receive RF signals. For example, RF analog signals received from multiple optical repeaters and summed in the CDMA master base station have different signal transmission loss and delay characteristics due to differences in the size and temperature of the optical cable connecting the optical repeaters to the CDMA master base station. There is no adequate provision in the related art to adjust transmission signals of respective optical repeaters to provide uniform signal amplitudes. Thus, the combined signal Arf_m(t) obtains a noise characteristic of the worst optical repeater among N optical repeaters.

Approaches that seek to obviate the problem by requiring a uniform length for optical cables 1-N are not cost effective due to the expense of additional optical cable that would be required on all but the longest route.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide an optical repeater system and method that is cost effective.

Another object of the present invention is to provide an optical repeater system and method that utilizes optical cable without being affected by length and temperature of the optical cable connecting the respective optical repeaters and base station.

Another object of the present invention is to reduce noise in signals received in optical repeaters and transmitted to a base station.

In order to achieve at least the above objects in whole or in part, and in accordance with the purposes of the present invention, as embodied and broadly described, there is provided an optical repeater system, including a plurality of optical repeaters coupled in series, each configured to receive and convert a radio frequency (RF) analog signal to a first baseband digital electrical signal, sum the first baseband digital electrical signal and a second baseband digital electrical signal transmitted from a previous optical repeater in the series to generate an optical signal, and a base station configured to receive and demodulate the optical output signal of a last one of the plurality optical repeater in the series.

To further achieve at least the above objects in whole or in part, and in accordance with the purpose of the present invention, as embodied and broadly described there is provided a method for receiving in an optical repeater, including receiving and converting a radio frequency (RF) analog signal to a first baseband digital signal in a first repeater, summing the first baseband digital signal with a second baseband digital signal receiving from a second repeater, converting an output of the summer to an optical output signal, and transmitting the optical output signal to a base station.

To further achieve at least the above objects in whole or in part, and in accordance with the purpose of the present invention, as embodied and broadly described, there is provided a method for receiving in a first optical repeater, including receiving and amplifying a radio frequency (RF) analog signal, converting the amplified RF analog signal to a first baseband digital signal, delaying the first baseband digital signal, summing the delayed first baseband digital signal and a second baseband digital signal received from a second optical repeater to generate an electrical output signal, converting the electrical output signal to an optical output signal, and transmitting the summed baseband digital signal to a base station.

To further achieve at least the above objects in whole or in part, and in accordance with the purpose of the present invention, as embodied and broadly described, there is provided an optical repeater system, including a first optical repeater configured to receive a first RF analog signal and output a first baseband digital optical signal, a second optical repeater coupled to the first optical repeater and configured to receive a second RF analog signal, convert the second RF analog signal to a first baseband digital electrical signal, delay the first baseband digital electrical signal, convert the first baseband digital optical signal to a second baseband digital electrical signal, sum the delayed first baseband digital electrical signal and the second baseband digital electrical signal, and convert the summed signal to a second baseband digital optical signal, and a base station coupled to the second optical repeater and configured to convert the second baseband digital optical signal to a third baseband digital electrical signal and demodulate the third baseband digital electrical signal.

To further achieve at least the above objects in whole or in part, and in accordance with the purpose of the present invention, as embodied and broadly described, there is provided an optical repeater system, including a first optical repeater configured to receive and convert a first radio frequency (RF) signal to a first baseband digital electrical signal and convert the first baseband digital electrical to a first optical signal, a second optical repeater coupled to receive the first optical signal from the first optical repeater and configured to receive and convert a second RF signal to a second baseband digital electrical signal, convert the first optical signal to an input electrical signal, add the second baseband digital electrical signal to the input electrical signal to generate a summed electrical digital signal, and convert the summed electrical digital signal to a second optical signal, and a base station configured to receive and demodulate the second optical signal.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram showing a related art optical communication system including analog optical repeaters; and

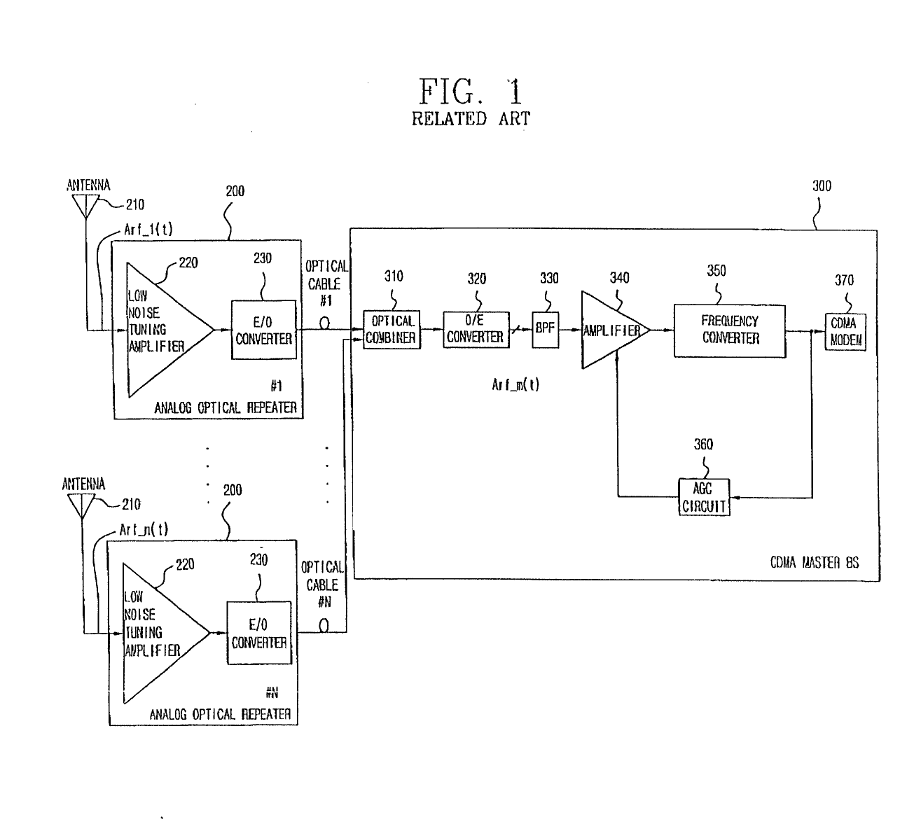

FIG. 2 is a block diagram showing an optical communication system including digital optical repeaters with daisy chain connection in accordance with a preferred embodiment of the present invention.

### DETAILED DESCRIPTION OF PREFERRED EMBODIMENTS

Reference will now be made in detail to the preferred embodiments of the present invention, examples of which are illustrated in the accompanying drawings.

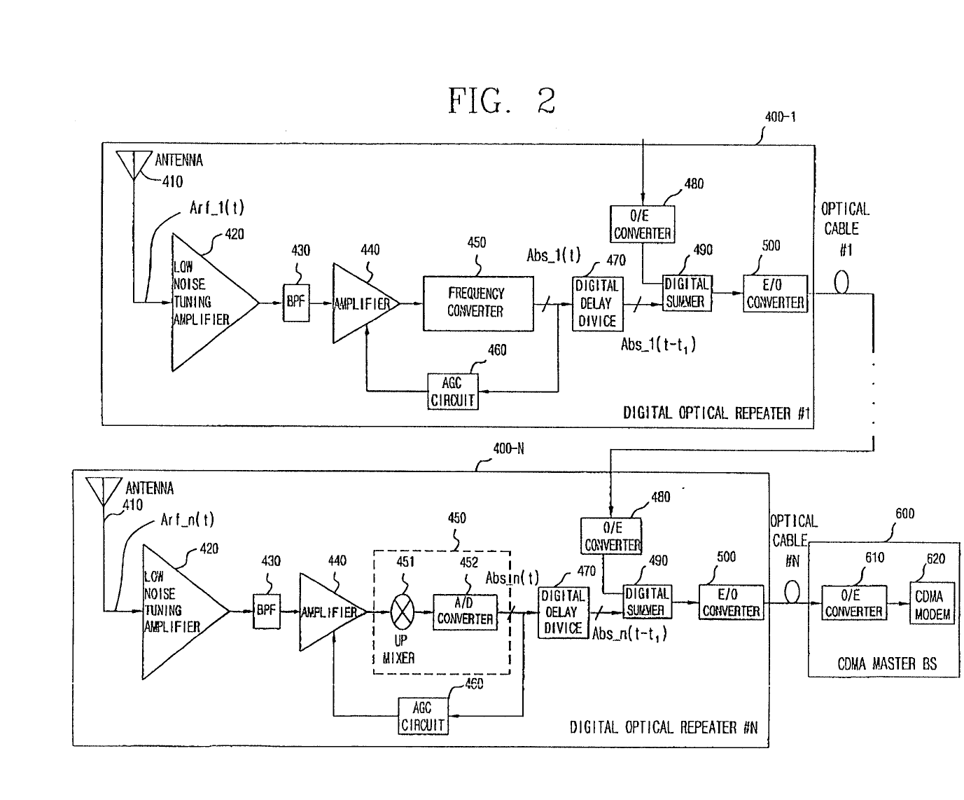

As shown in FIG. 2, an optical communication system in accordance with the preferred embodiment preferably includes a plurality (1-N) of digital optical repeaters 400-1, 400-N to convert the RF analog signal to a baseband digital signal and transmit the baseband digital signal to the following stage, and a CDMA or other master base station 600 to receive the baseband digital signal from the last optical repeater. The plurality (1-N) of optical repeaters 400 are preferably daisy chain connected.

Daisy chain connection is a structure that connects hardware devices in series. For example, device A is connected to a device B, and device B is connected to device C. The last device is preferably connected to a resistance device or a terminal device. Each device can preferably adjust one or more signals before transmitting the signals to the next device included in the daisy chain.

The optical repeater 400 preferably includes an antenna 410 to receive the RF analog signal Arf_{—}1(t), a low noise tuning amplifier 420 to amplify the analog signal Arf_{—}1(t) and a band-pass filter (BPF) 430 to filter the RF analog signal received from the low noise tuning amplifier 420 to a prescribed band. The optical repeater 400 also preferably includes an amplifier 440 to amplify the received RF analog signal passed through BPF 430 with a prescribed gain, Frequency converter 450 to convert the RF analog signal outputted from the amplifier 440 to a baseband digital signal, and a digital delay device 470 to delay the baseband digital signal outputted from the Frequency converter to match a round trip delay time of each optical repeater. The optical repeater 400 preferably further includes an Optical signal to Electric signal digital converter (O/E converter) 480 to convert the baseband digital optical signal received from another remote optical repeater to a baseband digital electrical signal, a digital summer 490 to sum the baseband digital signal outputted from the Frequency converter 450 and the baseband digital signal outputted from the O/E converter 480. The optical repeater 400 also preferably includes an Electric signal to Optical signal digital converter (E/O converter) 500 to convert the baseband digital electrical signal outputted from digital summer 490 to a baseband digital optical signal and an automatic gain control (AGC) circuit 460 to maintain a uniform gain of the amplifier 440.

The CDMA master station 600 preferably includes an Optical signal to Electric signal digital converter (O/E converter) 610 to convert the baseband digital optical signal received from the E/O converter 500 through the optical cable into a baseband digital electrical signal. The CDMA master station 600 also preferably includes a CDMA modem 620 to demodulate the baseband signal outputted from the O/E converter 610.

A Mixer 451 of the Frequency converter 450 preferably converts the RF analog signal received from amplifier 440 to a baseband analog signal. An analog-to-digital converter (ADC) 452 preferably converts baseband analog signal received from the Mixer 451 to a baseband digital signal and transmits the baseband digital signal, Abs_{—}1(t) for example, to the digital delay device 470.

The process of signal processing an optical communication system including digital optical repeaters that are daisy chain connected in accordance with a preferred embodiment of the present invention will be described with reference to FIG. 2.

The antenna 410 of the optical repeater 400 preferably receives a RF analog signal, Arf_{—}1(t) for example, and transmit the received RF analog signal to the low noise tuning amplifier 420. The low noise tuning amplifier 420 preferably amplifies the RF signal while maintaining a low noise level and transmits the RF signal having the low noise level to the BPF 430. The BPF 430 preferably filters the received RF analog signal and transmits the filtered RF analog signal to the amplifier 440. The amplifier 440 preferably amplifies the received RF analog signal using a prescribed gain and transmits the amplified RF analog signal to the Frequency converter 450.

The Mixer 451 of the frequency converter 450 preferably converts the RF analog signal received from amplifier 440 to a baseband analog signal. The ADC 452 of the frequency converter 450 preferably converts the baseband analog signal received from the Mixer 451 to a baseband digital signal and transmits the baseband digital signal, Abs_{—}1(t) for example, to the digital delay device 470. The digital delay device 470 preferably delays the received baseband digital signal to match the round trip delay time of at least one other optical repeater and transmits the delayed baseband digital signal, Abs_{—}1(t-t1) for example, to the digital summer 490.

The O/E converter 480 preferably receives the baseband digital optical signal transmitted from another optical repeater, converts the received baseband digital optical signal to a baseband digital electrical signal and transmits the signal to the digital summer 490. The digital summer 490 preferably sums the signal Abs_{—}1(t-t1), for example, received from the digital delay device 470 and the baseband digital signal received from the O/E converter 480 and transmits the summed signal to the E/O converter 500. The E/O converter 500 preferably converts the received baseband digital electrical signal into a baseband digital optical signal and then outputs the converted baseband digital optical signal to the optical repeater. The process described above for generating and outputting a signal to the next optical repeater is preferably repeated until the outputted signal is received by a final (n^{th}) optical repeater.

The baseband digital optical signal outputted from the final optical repeater is preferably transmitted to the O/E converter 610 of the CDMA master base station 600 through the optical cable. The O/E converter 610 preferably converts the received baseband digital optical signal to a baseband digital electrical signal and transmits the signal to the CDMA modem 620. The CDMA modem 620 preferably demodulates the received baseband digital signal.

The system and method of daisy-chained optical repeaters have various advantages. For example, the present invention can reduce the amount of optical cable required for a repeater network. In addition, transmission losses due to the length and temperature of the optical cable are minimized. Moreover, even where a transmission loss is generated due to the transmission length and temperature of the optical cable, in the present invention, an additional circuit compensating for the loss is not necessary. Also, with the present invention, the RF signal received in the base station is not affected by the received noise characteristic of the worst remote optical repeater in a group of optical repeaters nor is the received RF signal affected by noise introduced by the E/O or O/E converters. A further advantage of the present invention is that the round trip delay of respective repeaters can be easily performed using the highly accurate digital delay device.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An optical repeater system, comprising:
a plurality of optical repeaters coupled in series, each configured to receive and convert a radio frequency (RF) analog signal To a first baseband digital electrical signal, sum the first baseband digital electrical signal and a second baseband digital electrical signal transmitted from a previous optical repeater in the series to generate an optical output signal; and
a base station configured to receive and demodulate the optical output signal of a last one of the plurality of optical repeaters in the series.

2. A system of claim 1, wherein the second baseband digital electrical signal transmitted from a previous optical repeater in the series is a previously summed signal.

3. The system of claim 1, wherein the series connection comprises a daisy chain connection.

4. The system of claim 1, wherein each optical repeater comprises:
a band-pass filter (BPF) configured to filter the received RF analog signal and output a filtered RF analog signal;
an amplifier configured to amplify the filtered RF analog signal with a gain and output an amplified RF analog signal;
a frequency converter configured to convert the amplified RF analog signal to the first baseband digital electrical signal:
a digital delay device configured to delay the first baseband digital electrical signal;
an Optical signal to Electrical signal converter (O/E converter) configured to convert a baseband digital optical signal received from the previous optical repeater to the second baseband digital electrical signal;
a digital summer configured to sum the first baseband digital electrical signal and the second baseband digital electrical signal; and
an Electrical signal to Optical signal digital converter (E/O converter) configured to convert a summed signal outputted from the digital summer to the optical output signal.

5. The apparatus of claim 4, wherein the digital delay device delays the first baseband digital electrical signal to match a round trip delay time of each optical repeater.

6. The apparatus of claim 4, further comprising an automatic gain control (AGC) circuit configured to control the gain of the amplifier, wherein the AGC circuit controls the amplifier to maintain a uniform amplitude of the amplified RF analog signal.

7. The apparatus of claim 1, wherein each of the plurality of optical repeaters is coupled with at least one other of the plurality of optical repeaters by an optical link.

8. The apparatus of claim 7, wherein the optical link comprises an optical cable.

9. The apparatus of claim 1, wherein the last optical repeater is coupled with the base station by an optical cable.

10. A method for receiving in an optical repeater, comprising:
receiving and converting a radio frequency (RF) analog signal to a first baseband digital signal in a first repeater;
summing the first baseband digital signal with a second baseband digital signal received from a second repeater;
Converting an output of the summer to an optical output signal; and
transmitting the optical output signal to a base station.

11. The method of claim 10, further comprising:
receiving the optical output signal in the base station;
converting the received optical output signal to an electrical signal; and
demodulating the converted electrical signal.

12. The method of claim 10, wherein converting the RF analog signal comprises amplifying the RF analog signal with a prescribed gain in accordance with an automatic gain control circuit to maintain a prescribed amplitude of the amplified RF analog signal.

13. The method of claim 10, wherein the first baseband digital signal is delayed to match a round trip delay time of at least one other optical repeater coupled in series.

14. The method of claim 10, further comprising receiving an optical input signal from the second repeater and converting the optical input signal into the second baseband digital signal.

15. The method of claim 10, wherein the second baseband digital signal from the second repeater is a sum of baseband digital signals from a plurality of optical repeaters.

16. The method claim 10, wherein the optical output signal is transmitted to the base station over an optical cable.

17. A method for receiving in a first optical repeater, comprising:
receiving and amplifying a radio frequency (RF) analog signal;
converting the amplified RF analog signal to a first baseband digital signal;
delaying the first baseband digital signal;
summing the delayed first baseband digital signal and a second baseband digital signal received from a second optical repeater to generate an electric output signal;
converting the electrical output signal to an optical output signal; and
transmitting the optical output signal to a base station.

18. The method of claim 17, wherein amplifying the RF signal comprises applying a gain to maintain a prescribed amplitude of the amplified RF analog signal in accordance with an automatic gain control (AGC).

19. The method of claim 17, wherein the first baseband signal is delayed by an amount of delay necessary to match a round trip delay time of at least one second optical repeater.

20. The method of claim 17, wherein the first optical repeater is a final optical repeater in a series connected chain of optical repeaters.

21. The method of claim 17, further comprising receiving and optical input signal from the second optical repeater and converting the optical input signal to the second baseband digital signal.

22. The method of claim 21, wherein the optical input signal is received from the second optical repeater over an optical cable.

23. An optical repeater system, comprising:
first optical repeater configured to receive a first radio frequency (RF) analog signal and output a first baseband digital optical signal;
a second optical repeater coupled to the first optical repeater and configured to receive a second RF analog signal, convert the second RF analog signal to a first baseband digital electrical signal, delay the first baseband digital electrical signal, convert the first baseband digital optical signal to a second baseband digital electrical signal, sum the delayed first baseband digital electrical signal and the second baseband digital electrical signal, and convert the summed signal to a second baseband digital optical signal; and
a base station coupled to the second optical repeater and configured to signal and demodulate the third baseband digital electrical

[symbol]

24. The system of claim 23, further comprising an third optical repeater configured to receive a third RF analog signal and output a third baseband digital optical signal, wherein the first optical repeater is configured to convert the first RF analog signal to a fourth baseband digital electrical signal, delay the fourth baseband digital electrical signal, convert the third baseband digital optical signal to a fifth baseband digital electrical signal, sum the delayed fourth baseband digital electrical signal and the fifth baseband digital electrical signal, and convert the sum of the fourth and fifth baseband digital electrical signals to the first baseband digital optical signal.

25. The system of claim 23, wherein each of the first and second optical repeaters comprise:
a band-pass filter (BPF) configured to filter the received RF analog signal and output a filtered RF analog signal;
an amplifier configured to amplify the filtered RF analog signal with a gain and output an amplified RF analog signal;
a frequency converter configured to convert the amplified RF analog signal to the first baseband digital electrical signal:
a digital delay device configured to delay the first baseband digital electrical signal;
an Optical signal to Electrical signal converter (O/E, converter) configured to convert a baseband digital optical signal received from the previous optical repeater to the second baseband digital electrical signal;
a digital summer configured to sum the first baseband digital electrical signal and the second baseband digital electrical signal; and
an Electrical signal to Optical signal digital converter (E/O converter) configured to convert a summed signal outputted from the digital summer to the optic output signal.

26. An optical repeater system, comprising:
a first optical repeater configured to receive and convert a first radio frequency (RF) signal to a first baseband digital electrical signal and convert the first baseband digital electrical to a first optical signal;
a second optical repeater coupled to receive the first optical signal from the first optical repeater and configured to receive and convert a second RF signal to a second baseband digital electrical signal, convert the first optical signal to an input electrical signal, add the second baseband digital electrical signal to the input electrical signal to generate a summed electrical digital signal, and convert the summed electrical digital signal to a second optical signal; and
a base station configured to receive and demodulate the second optical signal.

27. The system of claim 26, wherein the first optical repeater is further configured to receive an external optical signal from a third optical repeater, convert the external optical signal to a second input electrical signal, and sum the second input electrical signal with the first baseband digital electrical signal and convert the sum to the first optical signal.

28. The system of claim 26, wherein each of the first and second optical repeaters comprise:
a band-pass filter (BPF) configured to filter the received RF analog signal and output a filtered RF analog signal;
an amplifier configured to amplify the filtered RF analog signal with a gain and output an amplified RF analog signal;
a frequency converter configured to convert the amplified RF analog signal to the first baseband digital electrical signal:
a digital delay device configured to delay the first baseband digital electrical signal;
an Optical signal to Electrical signal converter (O/E converter) configured to convert a baseband digital optical signal received from the previous optical repeater to the second baseband digital electrical signal;
a digital summer configured to sum the first baseband digital electrical signal and the second baseband digital electrical signal; and
an Electrical signal to Optical signal digital converter (E/O converter) configured to convert a summed signal outputted from the digital summer to the optical output signal.
